(19) United States
(12) Patent Application Publication
(10) Pub. No.: US 2024/0369686 A1
(43) Pub. Date: Nov. 7, 2024

(54) SCANNING OF SCAN REGIONS WITH OPTIMIZED CROSSTALK BEHAVIOR

(71) Applicant: Robert Bosch GmbH, Stuttgart (DE)

(72) Inventors: Johannes Richter, Renningen (DE); Mario Lietz, Vaihingen An Der Enz (DE)

(21) Appl. No.: 18/554,080

(22) PCT Filed: Apr. 25, 2022
(86) PCT No.: PCT/EP2022/060797

§ 371 Date: Oct. 5, 2023

(30) Foreign Application Priority Data
Apr. 30, 2021 (DE) 10 2021 204 319.4

(51) Int. Cl. G01S 7/48; G01S 7/481; G01S 7/497; G01S 17/42; G01S 17/894; G01S 17/931

(52) U.S. Cl. CPC G01S 7/4802; G01S 7/4808; G01S 7/4815; G01S 7/4817; G01S 17/42; G01S 17/894; G01S 17/931; G01S 2007/4977

(57) ABSTRACT

A method for scanning a scan region with a LIDAR system. Horizontal beams and vertical beams are generated. The horizontal beams are deflected and/or generated so as to be successively spatially offset along a vertical direction and emitted into the scan region and the vertical beams are deflected and/or generated so as to be successively spatially offset along a horizontal direction and emitted into the scan region. Beams that are backscattered and/or reflected from the scan region are received and guided onto at least one detector. A first point grid is determined based on the emitted horizontal beams received and a second point grid is determined based on the emitted vertical beams received. The first and second point grids are linked to one another. An object or object point is identified only if overlapping points of the first point grid and the second point grid are determined.

### FIELD

The present invention relates to a method for scanning a scan region with a LIDAR system and to a LIDAR system.

### BACKGROUND INFORMATION

Automated and partially automated vehicles are becoming increasingly important and will be used in public transport in the future. The concepts of such vehicles known to date require a combination of different sensors, such as camera sensors, LIDAR sensors and radar sensors, to enable the vehicle to be controlled safely on the road. LIDAR sensors use the so-called time-of-flight method to scan a scan region and determine a distance between a LIDAR sensor and measurement points in the scan region based on the determined time data.

The distance measurement of highly reflective objects is particularly problematic for LIDAR sensors with higher-resolution detectors. Such objects are, for example, traffic signs, vehicle-side reflectors, road-side reflectors and the like, and cause crosstalk of the detector. The beams that are backscattered or reflected by highly reflective objects have an increased intensity and expose neighboring detector pixels in addition to the detector pixels provided for this purpose, such that an evaluation of the measurement data is made difficult or prevented.

### SUMMARY

An object underlying the present invention includes providing a method and a LIDAR system, by which effects of a crosstalk of a detector when scanning highly reflective objects are at least reduced.

This object may be achieved by features of the present invention. Advantageous embodiments of the present invention are disclosed herein.

According to one aspect of the present invention, a method for scanning a scan region with a LIDAR system is provided. According to an example embodiment of the present invention, in one step, horizontal beams in the form of horizontal rows and vertical beams in the form of vertical columns are generated by at least one beam source. Preferably, the horizontal beams are deflected and/or generated so as to be successively spatially offset along a vertical direction and emitted into the scan region and the vertical beams are deflected and/or generated so as to be successively spatially offset along a horizontal direction and emitted into the scan region.

Beams that are backscattered and/or reflected from the scan region, particularly from objects or an environment, are received and guided onto at least one detector for the purpose of generating at least one first point grid and at least one second point grid.

The first point grid is determined on the basis of the horizontal beams emitted and received from the scan region, and the second point grid is determined on the basis of the vertical beams emitted and received from the scan region.

In a further step, the first point grid and the second point grid are linked to one another, wherein at least one object or at least one object point is identified only if overlapping points of the first point grid and the second point grid are determined.

According to an example embodiment of the present invention, the linkage of the points of the first point grid and the points of the second point grid may be effected for example by an AND logic.

The method results in a double scan of the scan region, which can be a vehicle environment, for example. In particular, the scan region is scanned with horizontal beams and additionally with vertical beams. In this case, the horizontal beams and the vertical beams are swept successively across the scan region in order to generate a point grid of measurement points and scan the entire scan region of the LIDAR system.

Due to the double scanning of the scan region, redundancy of the LIDAR system may be provided, offering increased measurement reliability. Through the linkage of the two point grids, they are overlapped. Subsequently, an AND operation is effected on the individual points of the point grids. The AND operation by the AND logic may be effected at the point cloud level or at the detector level. Thus, the AND operation may be implemented on the software side or on the hardware side.

Within the framework of the AND operation through the AND logic, each point of the first point grid is compared with each point of the second point grid. In this case, each point may form a so-called pixel in a resulting scan image. The AND logic may act as a filter here and “pass” only those points for further processing that are present in both point grids. Here, the points of the point grids represent objects or contours of an environment within the scan region. Thus, effects or impacts due to crosstalk of the detector, in particular impeded evaluation and loss of information, can be minimized or eliminated using the AND logic in combination with double scanning of the scan region.

Only if an object or an object point is present in both point grids and this has an approximately identical position or position data in both point grids, are these points of the two point grids combined to form an overlap point, which is further processed. This means that objects are only recognized or identified as real if there is an overlap within the point grids or scans. Thus, an object must be detected using both the horizontal beams and the vertical beams in order to be identified as a real object.

The method may reduce the number of false-positive results and compensate for measurement results due to scattered light, for example from rain or fog. In addition, resulting effects of crosstalk of the detector with highly reflective objects are compensated for by the method.

Depending on the design of the LIDAR system, the scan region is scanned several times per second. For each scan, a scan image or frame may be created in each case on the basis of the horizontal beams and on the basis of the vertical beams. Thus, every point of the frame is measured twice.

According to an example embodiment of the present invention, preferably, the method may be carried out by the LIDAR system with a control device. The control device may be, for example, a vehicle-side control device, a vehicle-external control device, a system-side or sensor-side control device or a vehicle-external server unit, such as a cloud system. The control device may preferably receive and process measurement data from the at least one detector of the LIDAR system. In this case, the control device may also be configured to control the LIDAR system, in particular the at least one radiation source of the LIDAR system.

The control device further has at least one internal or external memory, in order to store the measurement data of the at least one detector at least temporarily.

According to an example embodiment of the present invention, the measurement data of the at least one detector may be in the form of times or flight times of the beams or intensities and/or in the form of distances. At each measured point in the first point grid and/or in the second point grid, the so-called time-of-flight method may be applied. In this case, a lower intensity may always be used or processed to eliminate the effect of crosstalk. Depending on the design of the measured points, the time of flight or an intensity may be converted into a distance or a spacing between an object and the LIDAR system.

In one example embodiment of the present invention, the horizontal beams are generated by rows and the vertical beams by columns of a beam source designed as an array or as a matrix. In this case, the beam source may have a plurality of LEDs or lasers arranged in a predefined grid or pattern. In this case, different columns and rows of the beam source may be successively activated and deactivated in order to realize a spatial offset of the generated horizontal beams and vertical beams. Thereby, the control device may initiate or take over the control of the radiation source.

Depending on the design, the scan region may be scanned first with horizontal beams and subsequently with vertical beams. Alternatively, horizontal beams and vertical beams may be successively spatially offset in order to implement combined scanning of the scan region.

According to a further embodiment of the present invention, the horizontal beams are generated by at least one first beam source and the vertical beams are generated by at least one second beam source.

In this case, according to an example embodiment of the present invention, the horizontal beams and/or the vertical beams for scanning the scan region may be deflected by the particular beam sources in a spatially offset manner by at least one deflection unit along at least one solid angle. The at least one deflection unit may be, for example, a micromirror or a macromirror. Furthermore, the at least one deflection unit may be designed as a deflection prism or a turntable for rotating or pivoting the at least one first radiation source and/or for rotating or pivoting the at least one second radiation source.

This may provide multiple separate beam sources for generating the first point grid and for generating the second point grid.

According to a further exemplary embodiment of the present invention, the horizontal beams and the vertical beams are generated by shaping beams from at least one beam source by means of at least one optical system and are deflected to scan the scan region. In this case, the horizontal beams and the vertical beams may be formed, for example, by cylindrical lenses or diffractive optical elements from one or more point sources. Depending on the design, the deflection unit may deflect the shaped horizontal beams and vertical beams. Alternatively, the deflection unit may pivot or rotate the beam sources with the at least one optical system in order to scan the scan region.

According to a further embodiment of the present invention, the first point grid and the second point grid have a plurality of points that have position data and distance data. Alternatively or additionally, the points may have time data, in particular time-of-flight data of the beams. At least one point of the first point grid and at least one point of the second point grid having substantially equal position data are linked to at least one overlap point by the AND logic. The at least one overlap point is created by the AND logic if there are measurement points of an object in both the first point grid and the second point grid.

According to a further exemplary embodiment of the present invention, points of the first point grid having position data different from the position data of the points of the second point grid and points of the second point grid having position data different from the position data of the points of the first point grid are stored in a memory for carrying out diagnostics. The memory may be, for example, the internal or external memory of the control device. Through this measure, the data filtered out by the AND logic may be used for the self-diagnosis of the LIDAR system.

Thus, all points determined either within the first point grid or the second point grid, and thus blocked by the AND logic, may be further evaluated. For example, the distribution of such points may be analyzed. Randomly distributed points may be indicative of significant atmospheric scattering effects, such as rain, fog or dust.

According to a further embodiment of the present invention, an intensity distribution of the points of the first point grid and/or an intensity distribution of the points of the second point grid is determined, wherein at least one point spread function is determined on the basis of the intensity distributions of the points of the first point grid and/or the points of the second point grid.

For example, if crosstalk of detector pixels of the detector is determined, for example based on local overexposure or correlated intensity distributions of the points of the first point grid and the second point grid, the intensity distribution in the region of the points associated with the highly reflective object may be analyzed using the point spread function.

For example, the full width at half maximum or so-called FWHM of the point spread function of the points or pixels may be used to detect crosstalk of the LIDAR system. If the full width at half maximum of the point spread function of certain points is opposite to the full width at half maximum of a normalized or usual point spread function, the crosstalk of the LIDAR system can be assumed. Such increase in the full width at half maximum of the point spread function may be observed at points created by scanning highly reflective objects. In addition, there is a risk of crosstalk of the detector if the cover glass of the LIDAR system or the receiving optical system is dirty or obscured.

According to a further exemplary embodiment of the present invention, on the basis of the determined point spread function, a crosstalk of detector pixels of the detector within the first point cloud and/or the second point cloud is detected and an action, in particular a cleaning action, is initiated by a control device. By evaluating the point spread function of different points of the first point grid and/or the second point grid, optical impairments may be determined and actions may be initiated to eliminate the optical impairment. By this measure, contamination on a cover glass or protective glass of the LIDAR system may be detected and removed using the initiated action. For example, wiping devices or spray nozzles may be activated by the control device in order to eliminate the optical impairment.

According to a further example embodiment of the present invention, after an initiation of the action, the point spread function for detecting a crosstalk of detector pixels of the detector within the first point grid and/or the second point grid is determined, wherein if the crosstalk persists, a warning or an error is generated by the control device. If the optical impairment persists, which is determined by re-analyzing the point spread function, it may be assumed that the optical performance of the LIDAR system is permanently impaired. This also results in a permanent impairment of the crosstalk behavior. This may be caused, for example, by scratches or damage to the receiving optical system or by stubborn dirt. In addition, trapped dirt particles, such as dust, may form such an impairment.

By generating an error or a warning, a workshop visit may be initiated, by which the contamination is removed and/or damage is repaired.

According to a further exemplary embodiment of the present invention, the AND logic operation is carried out by at least one detector of the LIDAR system. Such an operation between the first point grid and the second point grid may be effected at the hardware level. In this case, the operation can be applied to the points of the first point grid and the second point grid, which are available as raw time information. This measure allows the number of measurement data to be processed to be reduced and only the relevant measurement data to be processed further.

According to a further aspect of the present invention, a LIDAR system is provided for carrying out the method according to the present invention. According to an example embodiment of the present invention, the LIDAR system has a control device for controlling the LIDAR system and for evaluating measurement data, in particular in the form of point grids, from at least one detector.

The LIDAR system may be arranged in a mobile unit, which may be operated in an assisted, partially automated, highly automated and/or fully automated or driverless manner in accordance with the BASt standard. For example, the mobile unit may be designed as a vehicle, a robot, a drone, a watercraft, a rail vehicle, a robotaxi, an industrial robot, a commercial vehicle, a bus, an aircraft, a helicopter and the like.

According to one exemplary embodiment of the present invention, the LIDAR system is designed as a flash LIDAR sensor, a set of at least two flash LIDAR sensors or a set of at least two scan LIDAR sensors. This allows the method to be carried out by a variety of different LIDAR systems. Conversely, the method is applicable to many different LIDAR systems to optimize the crosstalk behavior of sensor-side detectors.

According to a further embodiment of the present invention, the LIDAR system has at least one beam source for generating horizontal beams and/or vertical beams. Depending on the design of the LIDAR system, different beam sources may be used to generate horizontal and vertical beams.

Alternatively or additionally, a beam source, for example consisting of a plurality of LEDs or laser diodes, may be used to generate both horizontal and vertical beams. According to a further exemplary embodiment, the vertical beams and/or horizontal beams may thus be generated by the at least one beam source so as to be successively spatially offset in a horizontal direction and/or height direction.

Preferred exemplary embodiments of the present invention are explained in more detail below with reference to highly simplified schematic representations.

### BRIEF DESCRIPTION OF THE DRAWINGS

FIG. 1 shows an exemplary representation of a first point cloud and a second point cloud to illustrate a crosstalk behavior of a detector, according to an example embodiment of the present invention.

FIG. 2 shows a schematic representation of a LIDAR system according to a first example embodiment of the present invention.

FIG. 3 shows a schematic representation of a LIDAR system according to a second example embodiment of the present invention.

### DETAILED DESCRIPTION OF EXAMPLE EMBODIMENTS

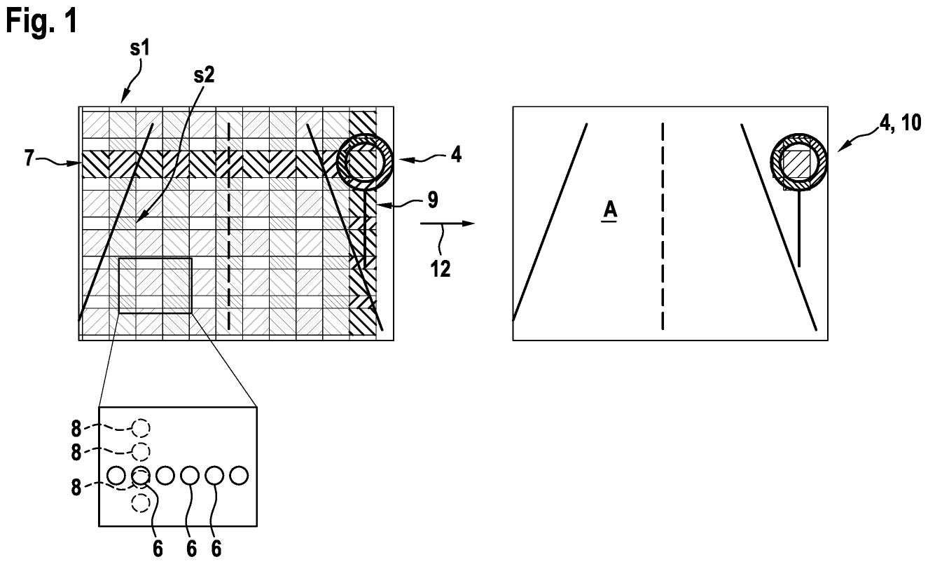

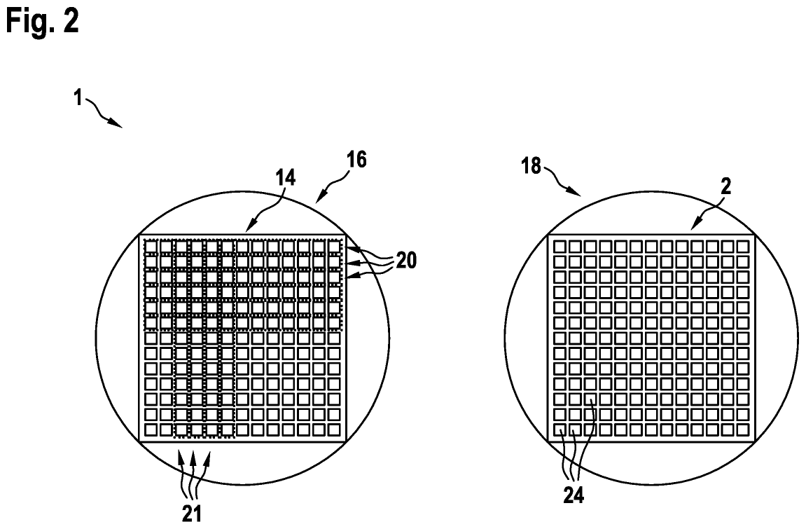

FIG. 1 shows an exemplary representation of a first point cloud p1 and a second point cloud p2 for illustrating a crosstalk behavior of a detector 2 of a LIDAR system 1 illustrated in FIG. 2. In particular, a method according to the present invention is illustrated. The first point cloud p1 and the second point cloud p2 are shown in a manner linked to one another and subsequently filtered using an AND operation or AND logic 12.

Crosstalk effects are particularly pronounced in LIDAR systems with parallel measurements, such as flash LIDAR. In this case, received beams cause crosstalk, with which a plurality of detector pixels not provided for the corresponding measurement are additionally exposed. Such effects occur, for example, when scanning highly reflective objects 4, such as retroreflectors or traffic signs.

In the exemplary embodiment shown, the highly reflective object 4 is designed as a traffic sign with a highly reflective surface. The object 4 is located in scan region A. The scan region A is exemplarily designed as a two-lane road.

The resulting measurements of detector 2 are shown overlapped. In particular, the first point cloud p1 is determined on the basis of the horizontal beams s1 emitted and received from a scan region A, and the second point cloud p2 is determined on the basis of the vertical beams s2 emitted and received from the scan region A.

The point clouds p1, p2 are shown overlapped on one another and in each case have a plurality of points or measurement points 6, 8. The points 6, 8 of the point clouds p1, p2 have position data or position information within the detection range of the LIDAR system 1 and distance information or distance data. The distance data may be in the form of intensities, time data or flight times of the beams and/or in the form of distance data. The particular points 6, 8 are also illustrated in FIG. 1, where an overlap between a point 6 of the first point cloud p1 and a point 8 of the second point cloud p2 is also visible.

A highly reflective object 4 is positioned in the detection range shown, which causes crosstalk of the detector 2. In this case, in the first point cloud p1 a horizontal crosstalk 7 or crosstalk of a column of the detector 2 and in the second point cloud p2 a vertical crosstalk 9 or crosstalk of a row of the detector 2 is illustrated.

By using an AND operation of the particular points 6, 8 of the point clouds p1, p2, only those points remain as overlap points 10 which are present in both point clouds p1, p2 with the same position data or at the same position within the detection range. Through this step, a measurement parallelization that optimizes a crosstalk behavior of the detector 2 may be realized.

In the exemplary embodiment shown, the vertical crosstalk 9 and the horizontal crosstalk 7 are filtered out by the AND operation, such that only one overlap point 10 for the highly reflective object 4 remains for further processing. For the sake of clarity, only one simplified object 4 is shown. However, the method is not limited to a number of objects to be detected.

Depending on the design, the object 4 may be mapped metrologically on the basis of a plurality of object points.

Corresponding object points are deemed to be identified or determined only if these object points are present both in the points of the first point cloud p1 and in the points of the second point cloud p2. This condition is fulfilled, for example, by the determined overlap point 10.

Through this, objects 4 or object points may be determined exclusively by redundant measurements using the vertical beams s2 and the horizontal beams s1, depending on the embodiment of the method.

In principle, in FIG. 1, there is a plurality of overlaps between the vertical beams s2 and the horizontal beams s1. Thus, parallel measurements of objects or an environment may be taken at many points in the scan region A. Only if a scanning of the scan region A with both horizontal beams s1 and vertical beams s2 results in a reflection or a backscatter from an object 4 is a combination to an overlap point 10 performed by the AND operation 12.

FIG. 2 shows a schematic representation of a LIDAR system 1 according to a first embodiment. The LIDAR system 1 has a radiation source 14 and a detector 2. In this case, a top view of the radiation source 14 is shown through a transmitting optical system 16 and a top view of the detector 2 is shown through a receiving optical system 18.

The transmitting optical system 16 is configured to shape the generated beams s1, s2 from the beam source 14 before they are emitted into the scan region A. Similarly, the receiving optical system 18 is configured to direct the beams reflected or backscattered from the scan region A at objects 4 to provided regions of the detector 2.

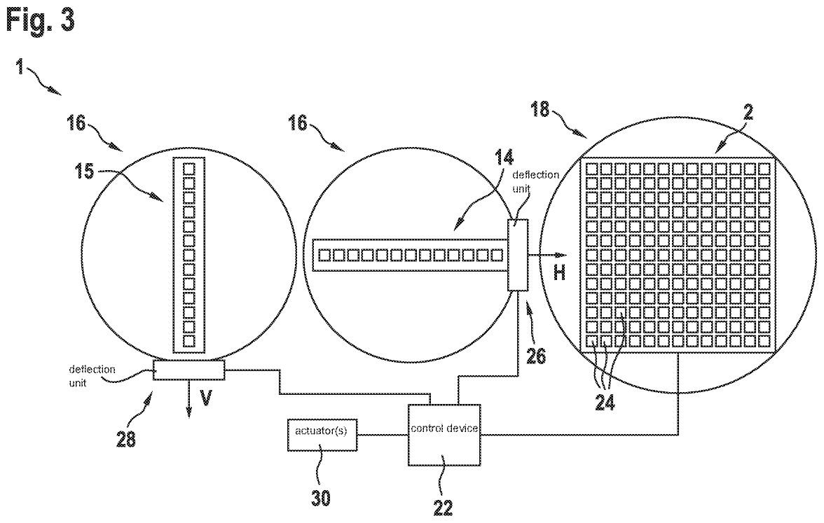

In the embodiment shown, the horizontal beams s1 are generated by rows 20 and the vertical beams s2 by columns 21 of a beam source 14 designed as an array or matrix. In this case, the beam source 14 may have a plurality of LEDs or lasers arranged in a predefined grid or pattern. In this case, different columns 21 and rows 20 of the beam source 14 may be activated and deactivated successively in order to realize a spatial offset of the generated horizontal beams s1 and vertical beams s2. Thereby, the control device 22 shown in FIG. 3 may initiate or take over the control of the radiation source 14.

Depending on the design, the scan region A may be scanned first with horizontal beams s1 and subsequently with vertical beams s2. Alternatively, horizontal beams s1 and vertical beams s2 may be successively spatially offset in order to implement a combined scanning of the scan region A. This means that it is not necessary to pivot or rotate the radiation source 14.

The detector 2 has a plurality of detector pixels 24 through which a plurality of measurement points 6, 8 can be determined and detailed scanning of the scan region A is made possible. The detector pixels 24 may be designed as SPAD diodes, for example.

FIG. 3 shows a schematic representation of a LIDAR system 1 according to a second embodiment. In this embodiment, the horizontal beams s1 are generated by at least one first beam source 14 and the vertical beams s2 are generated by at least one second beam source 15. The beam sources 14, 15 are positioned analogously to FIG. 2 behind corresponding transmitting optical systems 16, which are configured to form the beams s1, s2.

In this case, the horizontal beams s1 and/or the vertical beams s2 for scanning the scan region A may be deflected by the particular beam sources 14, 15 in a spatially offset manner by a deflection unit 26, 28 in each case along at least one solid angle. In the exemplary embodiment shown, the first beam source 14 is pivoted about a horizontal axis H by a first deflection unit 26. The second beam source 15 is pivoted about a vertical axis V by a second deflection unit 28. In this case, the horizontal axis H forms an axis of rotation of the first deflection unit 26 and the vertical axis V forms an axis of rotation of the second deflection unit 28.

The first beam source 14 is designed as a row-shaped array of LEDs or laser diodes. The second beam source 15 is designed as a column-shaped array of LEDs or laser diodes. The laser diodes may, for example, be designed as so-called VCSELs or surface emitters.

In an alternative design, the first beam source 14 and the second beam source 15 may be replaced by macroscanners or microscanners that have beam deflection or beam shaping corresponding to the extent of the particular arrays.

The deflection units 26, 28 are exemplarily designed as a turntable for rotating or pivoting the radiation sources 14, 15. Alternatively, rotating or pivoting mirrors or prisms may act as deflection units and deflect the generated beams s1, s2.

A control device 22 is provided in the LIDAR system 1, which control device may control the beam sources 14, 15, the deflection units 26, 28 and optional actuators 30. An actuator 30 may be designed, for example, to carry out actions, such as a pump for actuating cleaning nozzles. In addition, the control device 22 may be able to receive and analyze measurement data from the detector 2.

1-14. (canceled)

15. A method for scanning a scan region with a LIDAR system, the method comprising the following steps:
generating, by at least one beam source, horizontal beams in the form of horizontal rows and vertical beams in the form of vertical columns, wherein the horizontal beams are deflected and/or generated so as to be successively spatially offset along a vertical direction and emitted into the scan region, and the vertical beams are deflected and/or generated so as to be successively spatially offset along a horizontal direction and emitted into the scan region;
receiving and guiding beams that are backscattered and/or reflected from the scan region onto at least one detector to generate at least one first point grid and at least one second point grid, wherein the first point grid is determined based on the emitted horizontal beams received from the scan region and the second point grid is determined based on the emitted vertical beams received from the scan region;
linking the first point grid and the second point grid to one another; and
identifying at least one object or at least one object point only when overlapping points of the first point grid and of the second point grid are determined.

16. The method according to claim 15, wherein the horizontal beams are generated by rows of a beam source configured as an array or as a matrix, and the vertical beams are generated by columns of the beam source configured as the array or as the matrix.

17. The method according to claim 15, wherein the horizontal beams are generated by at least one first beam source and the vertical beams are generated by at least one second beam source.

18. The method according to claim 15, wherein the horizontal beams and the vertical beams are generated by shaping beams from the at least one beam source using at least one optical system and are deflected to scan the scan region.

19. The method according to claim 15, wherein each of the first point grid and the second point grid has a plurality of points that have position data and distance data, wherein at least one point of the first point grid and at least one point of the second point grid having substantially equal position data are linked to at least one overlap point by an AND logic.

20. The method according to claim 19, wherein the points of the first point grid having position data different from the position data of the points of the second point grid and the points of the second point grid having position data different from the position data of the points of the first point grid are stored in a memory for carrying out diagnostics.

21. The method according to claim 19, wherein an intensity distribution of the points of the first point grid and/or an intensity distribution of the points of the second point grid is determined, wherein at least one point spread function is determined based on the intensity distributions of the points of the first point grid and/or the points of the second point grid.

22. The method according to claim 21, wherein, based on the determined point spread function, a crosstalk of detector pixels of the detector within the first point grid and/or the second point grid is detected and an action is initiated by a control device.

23. The method according to claim 22, wherein the action is a cleaning action.

24. The method according to claim 22, wherein after an initiation of the action, the point spread function for detecting a crosstalk of detector pixels of the detector within the first point grid and/or the second point grid is determined, and wherein when the crosstalk persists, a warning or an error is generated by the control device.

25. The method according to claim 19, wherein the AND logic operation is carried out by at least one detector of the LIDAR system.

26. A LIDAR system, comprising:
a control device configured to control the LIDAR system and to evaluate measurement data in the form of point grids, from at least one detector;
wherein the LIDAR system is configured to scan a scan region, and wherein the LIDAR system is configured to:
generate, by at least one beam source, horizontal beams in the form of horizontal rows and vertical beams in the form of vertical columns, wherein the horizontal beams are deflected and/or generated so as to be successively spatially offset along a vertical direction and emitted into the scan region, and the vertical beams are deflected and/or generated so as to be successively spatially offset along a horizontal direction and emitted into the scan region,
receive and guide beams that are backscattered and/or reflected from the scan region onto at least one detector to generate at least one first point grid and at least one second point grid, wherein the first point grid is determined based on the emitted horizontal beams received from the scan region and the second point grid is determined based on the emitted vertical beams received from the scan region,
link the first point grid and the second point grid to one another, and
identify at least one object or at least one object point only when overlapping points of the first point grid and of the second point grid are determined.

27. The LIDAR system according to claim 26, wherein the LIDAR system is a flash LIDAR sensor, or a set of at least two flash LIDAR sensors. or a set of at least two scan LIDAR sensors.

28. The LIDAR system according to claim 26, wherein the LIDAR system includes the at least one beam source configured to generating the horizontal beams and/or the vertical beams.

29. The LIDAR system according to claim 26, wherein the vertical beams and/or horizontal beams are generated by the at least one beam source so as to be successively spatially offset in the horizontal direction and/or the vertical direction.
